(19) United States
(12) Patent Application Publication
(10) Pub. No.: US 2021/0311795 A1
(43) Pub. Date: Oct. 7, 2021

(54) METHOD AND APPARATUS FOR ALLOCATING DATABASE SERVER

(71) Applicant: Electronics and Telecommunications Research Institute, Daejeon (KR)

(72) Inventor: Soo Young JANG, Daejeon (KR)

(73) Assignee: Electronics and Telecommunications Research Institute, Daejeon (KR)

(21) Appl. No.: 17/219,258

(22) Filed: Mar. 31, 2021

(30) Foreign Application Priority Data
Apr. 2, 2020 (KR) 10-2020-0040085

(51) Int. Cl. G06F 9/50; G06F 16/27; G06F 16/28

(52) U.S. Cl. CPC G06F 9/5027; G06F 16/285; G06F 16/27

(57) ABSTRACT

The present disclosure provides a database server allocation method and apparatus. The database server allocation method may be performed by an allocation server interfaced with a plurality of database servers each of which collects data from one or more data generators. The method includes: allocating an initial database server for each data generator; receiving information on an amount of data generated by each data generator from the plurality of database servers; analyzing the amount of the data generated by each data generator to determine a data generation pattern for each data generator; and grouping the data generators according to the data generation pattern for each data generator and reallocating a new database server for each data generator.

### CROSS-REFERENCE TO RELATED APPLICATION

The present application claims priority to Korean Patent Application No. 10-2020-0040085 filed on Apr. 2, 2020 with the Korean Intellectual Property Office (KIPO), the entire content of which is incorporated herein by reference.

### BACKGROUND

### 1. Technical Field

The present disclosure relates to a method and apparatus for allocating a database server and, more particularly, to a method and apparatus for allocating database servers to data generating devices in a distributed system.

### 2. Related Art

Gigantic developments of information and communication technologies such as Internet of Things (IoT), Internet of Everything (IoE), and Cyber-Physical System (CPS) have brought about changes in an industrial system structure and human lifestyle. Various types of sensors such as a temperature sensor, a humidity sensor, an ultrasound sensor, an acceleration sensor, an infrared sensor, a biometric sensor, an image sensor, and a position sensor and a variety of electronic devices such as a business tablet PC, an artificial reality (AR) or virtual reality (VR) device are being used in a wide range of industries such as manufacturing, financial, medical, and educational industries. Also, smart devices such as a smartphone and an artificial intelligence (AI) speaker have become necessities for work and life of individuals.

The rapid increase in a number of devices connected to the network resulted in an explosive expansion of the data which is generated, collected, and stored by the devices in a day. It has been reported that the amount of data generated by the data generating devices amounted to 2.5 exabytes a day in 2017. Though the generated data often contains patterns or implications that may be used for an analysis or prediction of natural or social phenomena, the generated data have been discarded usually because of the costs for the collection and storage of such data and the lack of technologies to find the implications from the large amount of data.

In recent years, big data technologies encompassing the data collection, storage, processing, and analysis have been remarkably developed owing to the performance improvement and the cost reduction in hardware and software aspects of the technologies. Accordingly, researchers from the industries, academia, research institutions, and local governments are conducting researches in collaboration with each other to find solutions to increase the efficiency of existing systems, prepare new engines for growth, and build sustainable communities from the data being accumulated. Therefore, there is a need for a method for collecting, storing, processing, and analyzing a large amount of data more efficiently.

### SUMMARY

Provided is a method of allocating a database server that may be performed by an allocation server interfaced with a plurality of database servers that collect data from one or more data generators.

Provided is a database server allocation apparatus interfaced with a plurality of database servers that collect data from one or more data generators.

Provided is a database server collecting data from one or more data generators.

According to an aspect of an exemplary embodiment, the present disclosure provides a database server allocation method performed by an allocation server interfaced with a plurality of database servers each of which collects data from one or more data generators. The database server allocation method includes: allocating an initial database server for each data generator; receiving information on an amount of data generated by each data generator from the plurality of database servers; analyzing the amount of the data generated by each data generator to determine a data generation pattern for each data generator; and grouping the data generators according to the data generation pattern for each data generator and reallocating a new database server for each data generator.

The information on the amount of the data generated by each data generator may include metadata on data collected from a corresponding data generator.

The metadata may include at least one of an identifier of the corresponding data generator, a timestamp of data, and a data size.

The data generation pattern may include a pattern of change over time in the amount of the data received from the data generator.

The operation of grouping the data generators and reallocating the new database server for each data generator may be performed such that a peak value of an amount of data generated by all data generators belonging to each group in a predetermined time period does not exceed a capacity of a new database server corresponding to the group.

The database server allocation method may further include: providing database server reallocation information to each data generator.

The operation of allocating the initial database server for each data generator may include: allocating the initial database server by determining a nearest database server or by a round-robin scheme.

According to another aspect of an exemplary embodiment, the present disclosure provides a database server allocation apparatus interfaced with a plurality of database servers each of which collects data from one or more data generators. The database server allocation apparatus includes a processor and a memory storing at least one instruction to be executed by the processor. The at least one instruction when executed by the processor causes the processor to: allocate an initial database server for each data generator; receive information on an amount of data generated by each data generator from the plurality of database servers; analyze the amount of the data generated by each data generator to determine a data generation pattern for each data generator; and group the data generators according to the data generation pattern for each data generator and reallocate a new database server for each data generator.

The information on the amount of the data generated by each data generator may include metadata on data collected from a corresponding data generator.

The metadata may include at least one of an identifier of the corresponding data generator, a timestamp of data, and a data size.

The data generation pattern may include a pattern of change over time in the amount of the data received from the data generator.

The instruction when executed by the processor causing the processor to group the data generators and reallocate the new database server for each data generator may include an instruction causing the processor to group the data generators and reallocate the new database server such that a peak value of an amount of data generated by all data generators belonging to each group in a predetermined time period does not exceed a capacity of a new database server corresponding to the group.

The at least one instruction when executed by the processor may further cause the processor to: provide database server reallocation information to each data generator.

The instruction when executed by the processor causing the processor to allocate the initial database server for each data generator may include: an instruction when executed by the processor causing the processor to allocate the initial database server by determining a nearest database server or by a round-robin scheme.

According to yet another aspect of an exemplary embodiment, the present disclosure provides a database server collecting data from one or more data generators. The database server includes a processor and a memory storing at least one instruction to be executed by the processor. The at least one instruction when executed by the processor causes the processor to: receive, from an allocation server, information of at least one data generator allocated to the database server; receive, from the at least one data generator, information on an amount of generated data; provide, to the allocation server, the information on the amount of the generated data from the at least one data generator; receive, from the allocation server, information of at least one new data generator reallocated according to a data generation pattern for each data generator; and provide database server reallocation information to the at least one new data generator.

The information on the amount of the data generated by each data generator may be metadata on data collected from a corresponding data generator and may include at least one of an identifier of the corresponding data generator, a timestamp of data, and a data size.

The data generation pattern may include a pattern of change over time in the amount of the data received from the data generator.

The database server reallocation information may be generated by the allocation server as a result of grouping the data generators and reallocating a new database server for each data generator such that a peak value of an amount of data generated by all data generators belonging to each group in a predetermined time period does not exceed a capacity of a new database server corresponding to the group.

According to exemplary embodiments of the present disclosure, it is possible to effectively reduce computing resources required to collect and store data generated by a plurality of data generators since the database server is allocated dynamically based on an analyzed time series pattern.

Also, the present disclosure obviates a separate router device since the data generators that directly transmits the data to the database server.

Accordingly, there is no need to consider any performance degradation due to additional equipment such as the routers other than the database server.

### BRIEF DESCRIPTION OF THE DRAWINGS

In order that the disclosure may be well understood, there will now be described various forms thereof, given by way of example, reference being made to the accompanying drawings, in which:

FIG. 1 is a table showing an example of performance test benchmark scores and prices for high end CPUs;

FIG. 2 illustrates an example of the horizontal scaling system employing a mongoDB system;

FIG. 3 is a result of a performance test using a Mongo DB, showing processing time according to a number of transmitted data;

FIG. 4 is a graph showing the performance test of FIG. 3 in a logarithmic scale;

FIG. 5 illustrates a distributed database system environment to which a method of the present disclosure is applied;

FIG. 6 is a flowchart illustrating a method of allocating a database server according to an exemplary embodiment of the present disclosure;

FIG. 7 illustrates an example of allocating an initial database server for each data generator according to an embodiment of the present disclosure;

FIGS. 8A and 8B illustrate an example of a change in an allocation of database servers over time according to an exemplary embodiment of the present disclosure;

FIG. 9 is a graph showing changes in amounts of generated data for data generators used for a performance evaluation;

FIGS. 10A and 10B show results of the performance evaluation before and after applying the method according to the present disclosure, respectively; and

FIG. 11 is a block diagram of a database server allocation apparatus according to an exemplary embodiment of the present disclosure.

The drawings described herein are for illustration purposes only and are not intended to limit the scope of the present disclosure in any way.

### DETAILED DESCRIPTION

For a more clear understanding of the features and advantages of the present disclosure, exemplary embodiments of the present disclosure will be described in detail with reference to the accompanied drawings. However, it should be understood that the present disclosure is not limited to particular embodiments disclosed herein but includes all modifications, equivalents, and alternatives falling within the spirit and scope of the present disclosure. In the drawings, similar or corresponding components may be designated by the same or similar reference numerals.

The terminologies including ordinals such as “first” and “second” designated for explaining various components in this specification are used to discriminate a component from the other ones but are not intended to be limiting to a specific component. For example, a second component may be referred to as a first component and, similarly, a first component may also be referred to as a second component without departing from the scope of the present disclosure. As used herein, the term “and/or” may include a presence of one or more of the associated listed items and any and all combinations of the listed items.

When a component is referred to as being “connected” or “coupled” to another component, the component may be directly connected or coupled logically or physically to the other component or indirectly through an object therebetween. Contrarily, when a component is referred to as being “directly connected” or “directly coupled” to another component, it is to be understood that there is no intervening object between the components. Other words used to describe the relationship between elements should be interpreted in a similar fashion.

The terminologies are used herein for the purpose of describing particular exemplary embodiments only and are not intended to limit the present disclosure. The singular forms include plural referents as well unless the context clearly dictates otherwise. Also, the expressions “comprises,” “includes,” “constructed,” “configured” are used to refer a presence of a combination of stated features, numbers, processing steps, operations, elements, or components, but are not intended to preclude a presence or addition of another feature, number, processing step, operation, element, or component.

Unless defined otherwise, all terms used herein, including technical or scientific terms, have the same meaning as commonly understood by those of ordinary skill in the art to which the present disclosure pertains. Terms such as those defined in a commonly used dictionary should be interpreted as having meanings consistent with their meanings in the context of related literatures and will not be interpreted as having ideal or excessively formal meanings unless explicitly defined in the present application.

Exemplary embodiments of the present disclosure will now be described in detail with reference to the accompanying drawings.

Scalability of a database server is essential in an application which requires a collection, storage, manipulation, and analysis of a large amount of data. Methods of increasing the scalability of a database may be classified into two categories: vertical scaling and horizontal scaling.

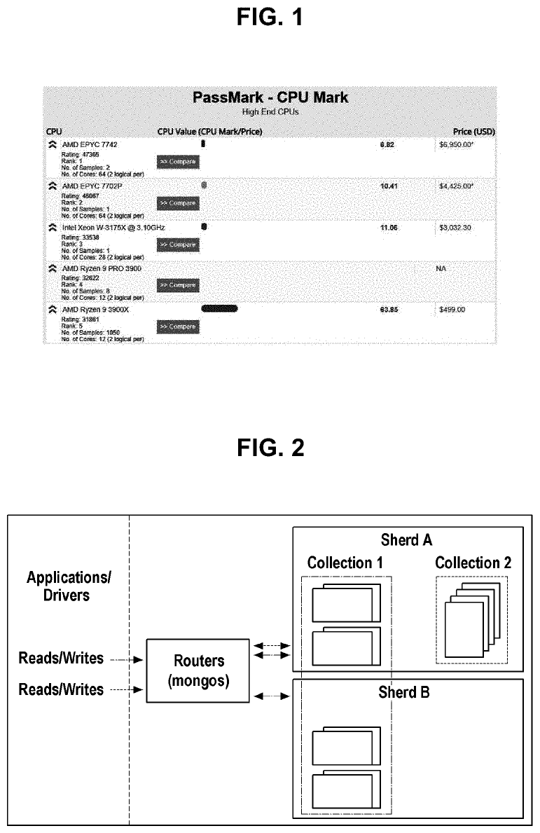

The vertical scaling is a method of increasing the physical performance of a database server by attaching a better CPU and increasing a size of a memory such as a RAM or a storage device in the server. This method is advantageous in that the infrastructure can be constructed easily and maintained conveniently. However, the performance of the database server cannot be increased indefinitely, and the performance does not increase in proportion to the price. FIG. 1 shows an example of performance test benchmark scores and prices for high end CPUs. It can be seen, in FIG. 1, that the more expensive CPUs exhibit the more sharply decreasing performance-to-price ratios.

The horizontal scaling is a method of distributing data and loads of a server to multiple servers. According to the horizontal scaling, the capacity and performance of the database system can be expanded by adding new servers whenever necessary. This method can enables to increase the scalability at a lower cost than the vertical scaling and is adopted in most systems. However, the horizontal scaling requires a distributed server infrastructure, and maintaining and managing the multiple servers is not easy or simple.

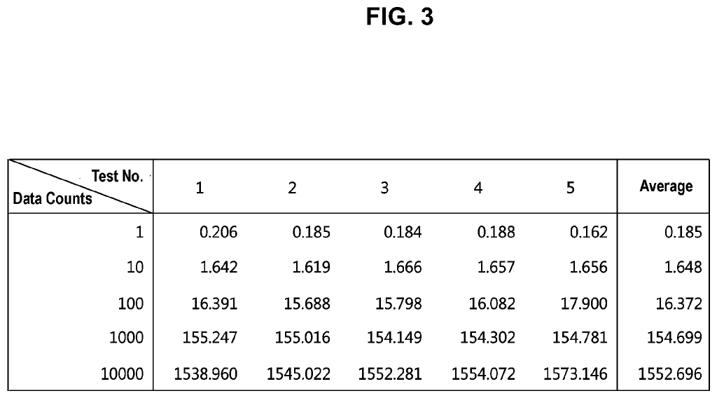

This method additionally requires equipments or software for distributing database task requests to the multiple servers or managing information distributed among the servers. Generally, a router is placed in front of the database servers as shown in FIG. 2, so that the router distributes the task requests across the database servers. FIG. 2 illustrates an example of the horizontal scaling system employing a mongoDB system. According to this method, however, if too many connections are established simultaneously, the loads on the router may obstruct a proper processing of the task requests. Moreover, this method further may require a configuration server for managing states of the database servers and configuration information such as addresses and access codes for connections between the router and the database servers.

The limitations of the vertical and horizontal scaling were examined by a performance test on database processing speeds according to an amount of collected data. The MongoDB system was used for the performance test. The MongoDB is a free database management system widely being used around the world, and ranked the 5th position among all the database management systems and the 1st position in the non-relational database category as of October 2019 according to DB-engines ranking (https://db-engines.com) which ranks the database management systems according to their popularity. However, since the MongoDB supports only a single core for writing, there is a limitation on a database write performance even if a multiple core server is used. The CPU of a PC used for the performance test was i9-9900K provided by Intel Corporation, having 16 cores, and operating at 3.6 GHz (16 Core), and the RAM of the PC was 64 gigabytes (GB).

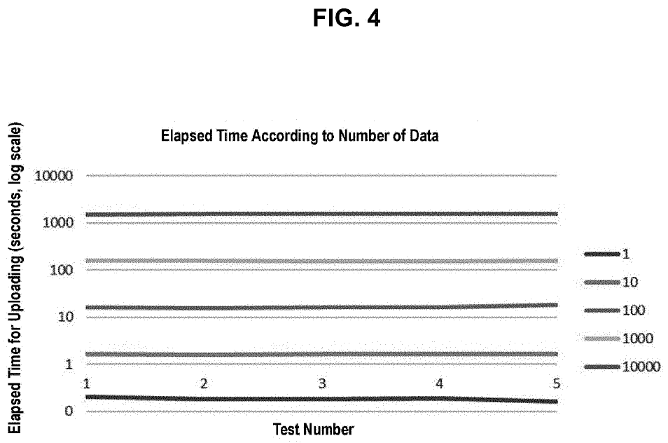

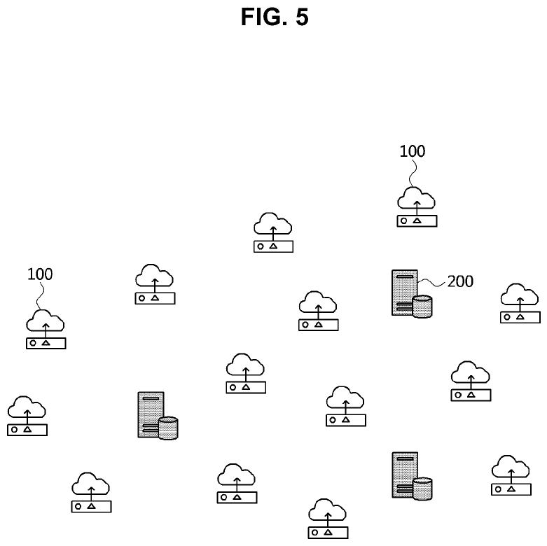

FIG. 3 is a result of the performance test using the Mongo DB, showing processing time according to a number of transmitted data. FIG. 4 is a graph showing the data of FIG. 3 in a logarithmic scale. In the performance test, times elapsed in store 1, 10, 100, 1,000, and 10,000 data were measured. A total of 5 measurements were taken, and an average was calculated for each data size. FIG. 3 summarizes the measurement results and the averages, and FIG. 4 is a graph showing the measurement results in the logarithmic scale.

It can be seen, in FIG. 4, that the time elapsed in the storage increased in proportion to the amount of data to be stored. Also, it can be seen, in FIG. 3, that it took 1552.7 seconds, i.e. about 26 minutes, to complete the collection or storage of 10,000 data. These figures may become big constraints in situations where large scale data is be collected and analyzed in real time, e.g. in a circumstance where data is collected and analyzed through a smart city platform and a result is shared among clients or users. A collection system is essential in order to solve this problem.

For example, an average number of data generated in a single intelligent CCTV may be 600 pieces per second assuming that:
frame rate per second: 30 frame per second (fps)
number of objects including persons and vehicles per frame: 20
number of events such as jaywalkers and transportation vulnerable persons: 0.1 cases/second.

If there are twenty CCTVs in the area, 12,000 data should be stored into the database server in a second. Such a data cannot be handled by a single high performance server, and it shows the limitation of the vertical scaling. Moreover, when a lot of data processing requests are generated in real time, the router at the front end is bound to receive a heavy load to route to the database servers located at the rear end, which leads to a performance degradation. Accordingly, there is a need for a system and method for efficiently distributing data collection tasks to multiple database servers by a method different from the router-based horizontal scaling.

The present disclosure proposes a system and method of allocating database servers to store data transmitted by data generators based on an analysis of a time series pattern in the amount of the generated data instead of a pattern inherent in the data itself. Typical examples having the time series pattern in the amount of the generated data include metadata of people and vehicles and safety event data generated in the intelligent CCTVs. Such data may have the time series pattern because the amount of the metadata and the event data is proportional to the flow of people and vehicles which are representative time series data.

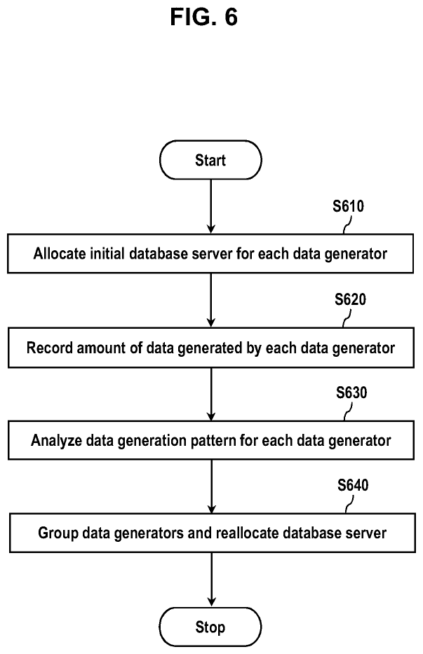

FIG. 5 illustrates a distributed database system environment to which the method of the present disclosure is applied. In the distributed database system environment shown in FIG. 5, a plurality of data generators 100 and a plurality of database servers 200 are arranged in distributed form.

The data generator 100 may refer a software or hardware device that generates data, and may include an intelligent CCTV, an IoT sensor, and the like. Referring to FIG. 5, one database server is allocated for each data generator 100. In other words, each data generator 100 is mapped to one of the plurality of database servers. The data generated by the data generator 100 is transmitted to an allocated database server and collected and stored in the database server.

In the present disclosure, the time series data generation pattern is analyzed and used for collecting and storing the data generated by the plurality of data generators to reduce the number of database servers and computing resources of the database servers.

The intelligent CCTV, which is an example of the data generator, may refer to a CCTV having an intelligent video analysis functionality. The intelligent CCTV may detect safety events on road such as a jaywalkers, a transportation vulnerable person, a fire, and throwing garbage and generate the metadata about the people and vehicles in the video by using the built-in video analysis function to send the safety event information and the metadata to the database server in addition to the captured video. The amount of the metadata generated by intelligent CCTV has a time series pattern because the amount of the metadata is proportional to the number of moving people and vehicles in a captured image and the number of moving people and vehicles may have the time series pattern in many cases. For example, the number of moving people and vehicles in a business town may be larger during rush hour than other times, and the number of moving people and vehicles around a tourist attraction area may be larger on weekends or holidays than weekdays.

When the number of moving people and vehicles increases in an area where the intelligent CCTV is located, the amount of generated data increases also. Contrarily, in case that the number of moving objects decreases, the amount of generated data decreases also. The present disclosure provides a method of efficiently grouping the data generators based on the data generation pattern and allocating each of the data generator groups to one of the plurality of database servers.

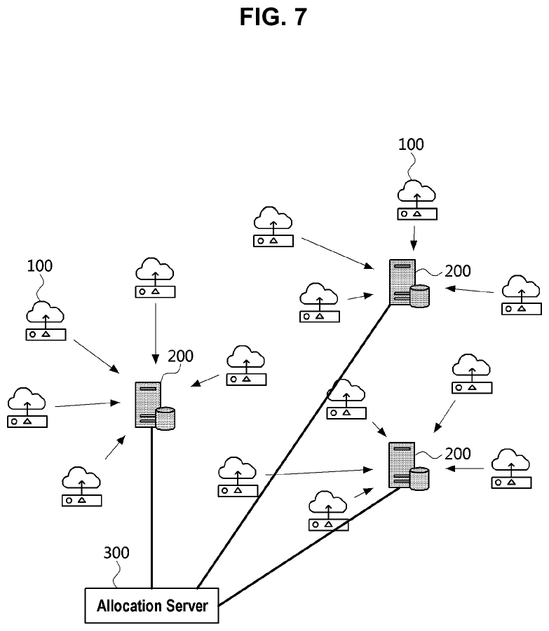

FIG. 6 is a flowchart illustrating a method of allocating the database server according to an exemplary embodiment of the present disclosure.

The method of allocating the database server based on the time series data generation pattern according to an embodiment of the present disclosure includes operations of allocating an initial database server for each data generator (S610), recording an amount of the data generated by each of the data generators (S620), analyzing a data generation pattern of the data generated by each of the data generator (S630), grouping the data generators based on the data generation pattern and reallocating the database server to each data generator (S640).

More specifically, in the operation of allocating an initial database server for each data generator (S610), a database server to transmit the generated data by the data generator may be allocated according to a conventional method. Examples of the conventional method may include an allocation of the data generator to a database server in a nearest location or an allocation of the data generators to the database servers in a round-robin scheme.

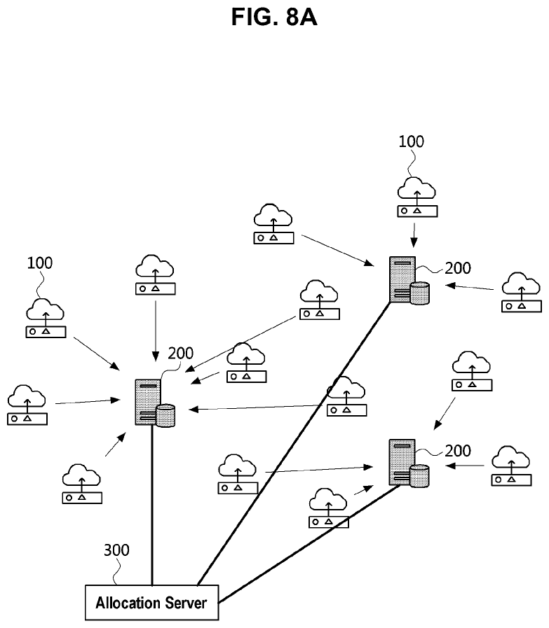

FIG. 7 illustrates an example of allocating an initial database server for each data generator according to an embodiment of the present disclosure.

In the example of FIG. 7, a database server 200 located closest to a data generator 100 is allocated to the data generator. Meanwhile, each database server may be interfaced with an allocation server 300 according to an exemplary embodiment of the present disclosure.

According to an exemplary embodiment of the present disclosure, the database server 200 may receive information on the amount of generated data from one or more data generators and provide such information to the allocation server. The database server 200 may receive information of one or more data generators reallocated for each data generator according to the data generation pattern from the allocation server to provide to the one or more data generators associated with the reallocation.

To this end, the database server may include a processor and a memory that stores at least one program instructions executable by the processor.

In addition, the allocation server 300 according to an exemplary embodiment of the present disclosure, which is a device allocating a database server to each data generator, is interfaced with the plurality of database servers each of which collects data from one or more data generators. The allocation server 300 analyzes the amount of data generated by each of the data generators received from the data generator to identify the data generation pattern, and groups the data generators according to the data generation pattern to reallocate the database server for each data generator.

Referring back to FIG. 6, in the operation S620, the amount of the data generated by each of the data generators is recorded. According to the present disclosure, the database server allocated to each of the data generators may change over time. Each database server may transmit the metadata for the collected data periodically to the allocation server. The metadata may include information such as a data generator identifier (ID), a timestamp, and a data size.

In the operation of analyzing the data generation pattern for each data generator (S630), the allocation server analyzes the metadata collected from the database servers to model the time series data generation pattern for each of the data generators.

In the operation of grouping the data generators and reallocating the database server (S640), the grouping of the data generators and the allocation of the database servers are performed by using the time series pattern modeled through the time series pattern analysis for each data generator. The grouping of the data generators and the allocation of the database servers may be performed together to take it into consideration when grouping data generators that the database servers may have different processing capabilities between each other.

Table 1, Equation 1, and Equation 2 show abbreviations, assumption, and formulations, respectively, for the grouping of the data generators and the allocation of the database servers according to an exemplary embodiment of the present disclosure. In the present embodiment, it is assumed that all the database servers have the same processing capabilities with each other.

Table 1 summarizes abbreviations in the Equations 1 and 2 used for grouping of the data generators.

TABLE 1

| | |
|---|---|
| Time | T = {t₀, t₁, . . . , t₁, . . . , t_{L}} |
| Device | D = {d₁, . . . , dₙ, . . . , d_{N}} |
| Device Group | G = {g₁, . . . , gₘ, . . . , g_{M}} |

In Table 1, ‘n,’ ‘m,’ and ‘l’ are indices for the data generator or data generating device, the group, and timing, respectively. ‘D’ denotes an entire data generator set, ‘G’ denotes an entire device group set. Also, ‘N’ denotes a total number of the data generators, ‘M’ denotes a total number of the groups, and ‘L’ denotes a total number of time units for the grouping the data generators and the allocation of the database servers. If the time unit is a day, ‘L’ may denote a day, and if the time unit is a week, ‘L’ may denote a week.

Equation 1 expresses an assumption for the grouping of the data generators and the allocation of the database servers.

$${⋃}_{n = 0}^{N} {g}_{n} = G \\ {g}_{i} ⋂ {g}_{j} = φ , for each i \neq j \qquad ( 1 )$$

In the Equation 1, ‘gᵢ’ and gⱼ′ denote groups different from each other. Equation 1 indicates that a union of all the groups should be an entire data generator set under a condition that an intersection between any two different groups is an empty set. According to this assumption, each all generator must belong to at least one device group and at most only one device group.

Equation 2 expresses a formulation scheme for the data generator groups according to an exemplary embodiment of the present disclosure.

$$Minimize M \\ subject to {max}_{0 \leq 1 \leq L} {\sum }_{i ∈ {g}_{m}} {\int }_{{t}_{l - 1}}^{{t}_{l}} {f}_{i} ( t ) d t \leq P , ∀ 1 \leq m \leq M \qquad ( 2 )$$

In the Equation 2, ‘fᵢ(t)’ denotes the amount of data generated by the data generator at a timing index i, and ‘P’ may denote the processing capacity of the database server. The amount of the generated data ‘fᵢ(t)’ forms a basis for the pattern analysis of the time series data generation.

According to the Equation 2, the grouping of the data generators and the reallocation of the database servers according to an exemplary embodiment of the present disclosure may be performed such that a peak value of the amount of the generated data during a certain period of time by all the data generators belonging to a group does not exceed a processing capacity of a corresponding database server and the total number of the groups, M, that is, the number of the database servers can be minimized.

According to the present disclosure, the database server allocated to a data generator may change over time correspondingly to a change in the time series pattern. For example, a first data generator may transmit the data a first server from 9 o'clock to 18 o'clock while transmitting the data to a second server from 18 o'clock to 9 o'clock. As mentioned above, the information of the grouping of the data generators and the allocation of the database servers is updated based on the analysis of the time series data generation pattern. Such information is provided to each of the data generators, so that the data generators may transmit the generated data to respectively allocated database server according to the updated information of the allocation of the database servers.

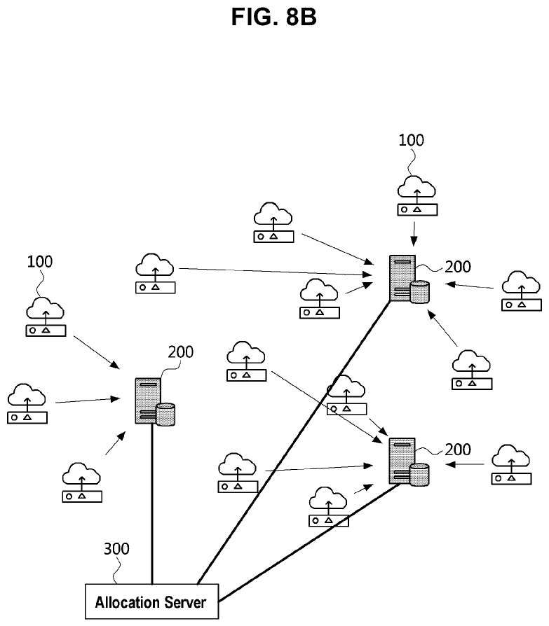

FIGS. 8A and 8B illustrate an example of a change in the allocation of the database servers over time according to an exemplary embodiment of the present disclosure.

FIG. 8A illustrates a case of allocating the database servers during a day time in a certain system environment while FIG. 8B illustrates a case of allocating the database servers during in a night time in the same system environment as FIG. 8A. It can be seen that the allocation of the database servers in the day time is different from that in the night time in the same system environment. Furthermore, the numbers of data generators allocated to the database servers in FIG. 8A are different from respectively corresponding numbers in FIG. 8B due to the reallocation based on the time series data generation pattern.

The database server allocation method according to the present disclosure was evaluated for performance compared to an existing method. A performance evaluation scenario was set such that seven data generators were grouped into three device groups and allocated to three database servers.

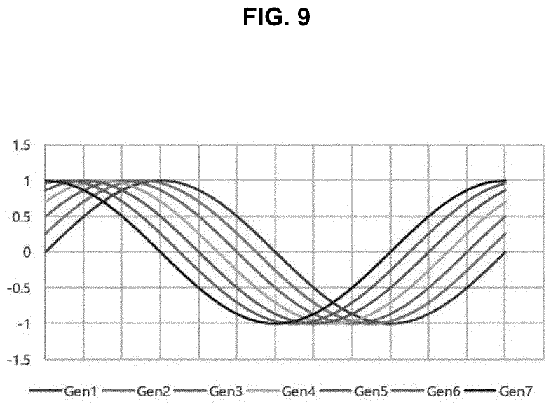

FIG. 9 is a graph showing changes in amounts of the generated data for the seven data generators used for the performance evaluation. In FIG. 9, ‘Gen1’ to ‘Gen7’ denote the data generators, the horizontal axis represents time, and the vertical axis represents the amount of the generated data over time.

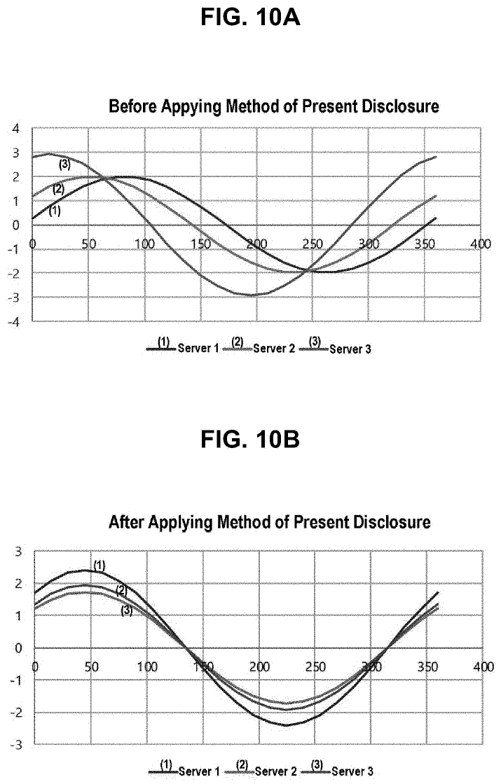

FIGS. 10A and 10B show the results of the performance evaluation before and after applying the method according to the present disclosure, respectively.

More specifically, FIG. 10A shows the amount of data collected by each of the database servers in case that the allocation method of the present disclosure is not applied and a conventional random grouping method was applied. FIG. 10B is a shows the amount of data collected by each of the database servers in the system in which the data generators were grouped using the time series pattern according to the present disclosure.

It can be seen, in FIGS. 10A and 10B, that the total amount of data to be processed is the same for the servers 1 to 3 but the amount of peak data for each server is different from each other. In case of the system to which the present disclosure is not applied, the peak value of the amount of the data processing requested in the server 3 was 2.93 as shown in FIG. 10A. In case of the system to which the present disclosure is applied, the peak value of the amount of the data processing requested in the server 3 was 2.41 as shown in FIG. 10B, which is a result improved by 17.8% in terms of the peak value.

The reason why the peak value is important is that if the peak value is larger than the processing capacity of the server, a data processing delay or data loss may occur near the peak point, and thus an installation of additional server may be required. For example, assuming that the processing capacity of a server is 2.5 in the examples of FIGS. 10A and 10B, the amount data collected by the server 3 is 2.93, which exceeds the processing capacity of the server in the case of FIG. 10A. Thus, the system to which the present disclosure is not applied requires an installation of an additional server, and thus the amount of required computing resources increases.

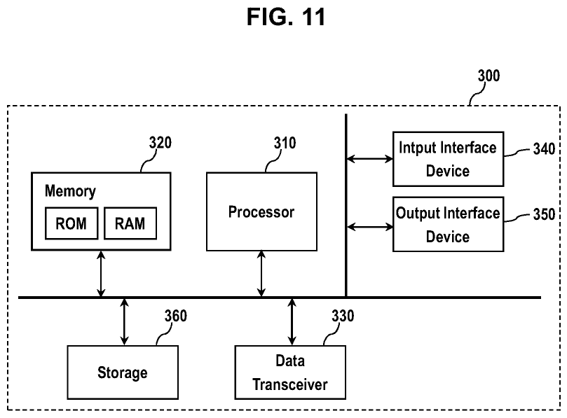

FIG. 11 is a block diagram of a database server allocation apparatus according to an embodiment of the present disclosure.

The database server allocation apparatus according to an exemplary embodiment of the present disclosure includes at least one processor 310, a memory 320 for storing at least one instruction to be executed by the processor, and a data transceiver 330 performing communications through a network. The server allocation device 300 may further include an input interface device 340, an output interface device 350, and a storage device 360. The components of the database server allocation apparatus 300 may be connected by a bus 370 to communicate with each other.

The processor 310 may execute program instructions stored in the memory 320 and/or the storage 360. The processor 310 may include a central processing unit (CPU), a graphics processing unit (GPU), or may be implemented by another kind of dedicated processor suitable for performing the methods of the present disclosure.

The memory 320 may load the program instructions stored in the storage 360 to provide to the processor 310. The memory 320 may include, for example, a volatile memory such as a read only memory (ROM) and a nonvolatile memory such as a random access memory (RAM).

The storage 360 may store the program instructions that can be loaded to the memory 320 and executed by the processor 310. The storage 360 may include an intangible recording medium suitable for storing the program instructions, data files, data structures, and a combination thereof. Examples of the storage medium may include magnetic media such as a hard disk, a floppy disk, and a magnetic tape, optical media such as a compact disk read only memory (CD-ROM) and a digital video disk (DVD), magneto-optical medium such as a floptical disk, and semiconductor memories such as ROM, RAM, a flash memory, and a solid-state drive (SSD).

The program instructions, when executed by the processor, may cause the processor to: allocate an initial database server for each data generator; receive information on an amount of data generated by each data generator from the plurality of database servers; analyze the amount of the data generated by each data generator to determine a data generation pattern for each data generator; and group the data generators according to the data generation pattern for each data generator and reallocate a new database server for each data generator.

The information on the amount of the data generated by each data generator may include metadata on data collected from a corresponding data generator.

The metadata may include at least one of an identifier of the corresponding data generator, a timestamp of data, and a data size.

The data generation pattern may include a pattern of change over time in the amount of the data received from the data generator.

The instruction causing the processor to group the data generators and reallocate the new database server for each data generator may include an instruction causing the processor to group the data generators and reallocate the new database server such that a peak value of an amount of data generated by all data generators belonging to each group in a predetermined time period does not exceed a capacity of a new database server corresponding to the group.

As mentioned above, the apparatus and method according to exemplary embodiments of the present disclosure can be implemented by computer-readable program codes or instructions stored on a computer-readable intangible recording medium. The computer-readable recording medium includes all types of recording device storing data which can be read by a computer system. The computer-readable recording medium may be distributed over computer systems connected through a network so that the computer-readable program or codes may be stored and executed in a distributed manner. The computer-readable recording medium may include a hardware device specially configured to store and execute program instructions, such as a ROM, RAM, and flash memory. The program instructions may include not only machine language codes generated by a compiler, but also high-level language codes executable by a computer using an interpreter or the like.

Some aspects of the present disclosure described above in the context of the apparatus may indicate corresponding descriptions of the method according to the present disclosure, and the blocks or devices may correspond to operations of the method or features of the operations. Similarly, some aspects described in the context of the method may be expressed by features of blocks, items, or devices corresponding thereto. Some or all of the operations of the method may be performed by use of a hardware device such as a microprocessor, a programmable computer, or electronic circuits, for example. In some exemplary embodiments, one or more of the most important operations of the method may be performed by such a device.

In some exemplary embodiments, a programmable logic device such as a field-programmable gate array may be used to perform some or all of the functions of the methods described herein. The field-programmable gate array may be operated along with a microprocessor to perform one of the methods described herein. In general, the methods may be performed preferably by a certain hardware device.

While the present disclosure has been described above with respect to exemplary embodiments thereof, it will be apparent to those skilled in the art that various changes and modifications may be made without departing from the spirit and scope of the present disclosure defined in the following claims.

What is claimed is:

1. A database server allocation method performed by an allocation server interfaced with a plurality of database servers each of which collects data from one or more data generators, comprising:
allocating an initial database server for each data generator;
receiving information on an amount of data generated by each data generator from the plurality of database servers;
analyzing the amount of the data generated by each data generator to determine a data generation pattern for each data generator; and
grouping the data generators according to the data generation pattern for each data generator and reallocating a new database server for each data generator.

2. The database server allocation method of claim 1, wherein the information on the amount of the data generated by each data generator comprises metadata on data collected from a corresponding data generator.

3. The database server allocation method of claim 2, wherein the metadata comprises at least one of an identifier of the corresponding data generator, a timestamp of data, and a data size.

4. The database server allocation method of claim 1, wherein the data generation pattern comprises a pattern of change over time in the amount of the data received from the data generator.

5. The database server allocation method of claim 1, wherein grouping the data generators and reallocating the new database server for each data generator is performed such that a peak value of an amount of data generated by all data generators belonging to each group in a predetermined time period does not exceed a capacity of a new database server corresponding to the group.

6. The database server allocation method of claim 1, further comprising:
providing database server reallocation information to each data generator.

7. The database server allocation method of claim 1, wherein allocating the initial database server for each data generator comprises:
allocating the initial database server by determining a nearest database server or by a round-robin scheme.

8. A database server allocation apparatus interfaced with a plurality of database servers each of which collects data from one or more data generators, comprising:
a processor; and
a memory storing at least one instruction to be executed by the processor,
wherein the at least one instruction when executed by the processor causes the processor to:
allocate an initial database server for each data generator;
receive information on an amount of data generated by each data generator from the plurality of database servers;
analyze the amount of the data generated by each data generator to determine a data generation pattern for each data generator; and
group the data generators according to the data generation pattern for each data generator and reallocate a new database server for each data generator.

9. The database server allocation apparatus of claim 8, wherein the information on the amount of the data generated by each data generator comprises metadata on data collected from a corresponding data generator.

10. The database server allocation apparatus of claim 9, wherein the metadata comprises at least one of an identifier of the corresponding data generator, a timestamp of data, and a data size.

11. The database server allocation apparatus of claim 9, wherein the data generation pattern comprises a pattern of change over time in the amount of the data received from the data generator.

12. The database server allocation apparatus of claim 8, wherein the instruction when executed by the processor causing the processor to group the data generators and reallocate the new database server for each data generator comprises an instruction when executed by the processor causes the processor to:
group the data generators and reallocate the new database server such that a peak value of an amount of data generated by all data generators belonging to each group in a predetermined time period does not exceed a capacity of a new database server corresponding to the group.

13. The database server allocation apparatus of claim 8, wherein the at least one instruction when executed by the processor further causes the processor to:
provide database server reallocation information to each data generator.

14. The database server allocation apparatus of claim 8, wherein the instruction when executed by the processor causing the processor to allocate the initial database server for each data generator comprises:
an instruction when executed by the processor causing the processor to allocate the initial database server by determining a nearest database server or by a round-robin scheme.

15. A database server collecting data from one or more data generators, comprising:
a processor; and
a memory storing at least one instruction to be executed by the processor,
wherein the at least one instruction when executed by the processor causes the processor to:
receive, from an allocation server, information of at least one data generator allocated to the database server;
receive, from the at least one data generator, information on an amount of generated data;
provide, to the allocation server, the information on the amount of the generated data from the at least one data generator;
receive, from the allocation server, information of at least one new data generator reallocated according to a data generation pattern for each data generator; and
provide database server reallocation information to the at least one new data generator.

16. The database server of claim 15, wherein the information on the amount of the data generated by each data generator is metadata on data collected from a corresponding data generator and comprises at least one of an identifier of the corresponding data generator, a timestamp of data, and a data size.

17. The database server of claim 15, wherein the data generation pattern comprises a pattern of change over time in the amount of the data received from the data generator.

18. The database server of claim 15, wherein the database server reallocation information is generated by the allocation server as a result of grouping the data generators and reallocating a new database server for each data generator such that a peak value of an amount of data generated by all data generators belonging to each group in a predetermined time period does not exceed a capacity of a new database server corresponding to the group.
